(19) United States
(12) Patent Application Publication
(10) Pub. No.: US 2003/0031095 A1
(43) Pub. Date: Feb. 13, 2003

(54) Portable hard disk system for an internet protocol network

(75) Inventor: Jae-Young Jeon, Anyang (KR)

Correspondence Address: FLESHNER & KIM, LLP, P.O. Box 221200, Chantilly, VA, 20153-1200, US

(73) Assignee: LG Electronics Inc.

(21) Appl. No.: 10/214,156

(22) Filed: Aug. 8, 2002

(30) Foreign Application Priority Data
Aug. 9, 2001 (KR) 48009/2001

(51) Int. Cl. H04B 1/20

(52) U.S. Cl. 369/1

(57) ABSTRACT

A hard disk system connected to a computer system through a network. The hard disk system includes a central processing unit (CPU) which is independent from a CPU of the computer system. The hard disk is configured so that the computer system can utilize the hard disk system in a similar manner as a hard disk rigidly attached to the computer system. However, since the hard disk system is not part of the computer system, it can be easily reconfigured for another computer system during an upgrade. Further, as the central processing unit of the hard drive system is independent from the computer system, the reconfiguration of the hard disk can be accomplished when the hard disk system is redesignated to another computer system.

### BACKGROUND OF THE INVENTION

1. Field of the Invention

The present invention relates to a portable hard disk system for an Internet Protocol network connection.

2. Background of the Related Art

Many computer systems include a central processing unit (CPU), read-only memory (ROM), random-access memory (RAM) and a data storage device. An example of a data storage device is a hard disk. A hard drive is typically a unit of the computer system. Accordingly, the hard disk is rigidly attached to the computer system. The computer system also includes software. Software is the set of instructions the computer follows to accomplish tasks. In a typical hard disk, which is rigidly attached to the computer system, information is necessary to operate the hard disk that included in the computer system.

It is often necessary for a hard drive to be separated from a computer system and relocated. Such instances are when the computer system is being updated. However the hard disk still contains information that is useful to a user. Another example is that the computer system may need to be reconfigured for a different application. However, the problem arises that when the hard disk is separated from the computer system the control information which is specific to the hard disk must also be transferred. This is not necessarily an easy task. Further, it is typical for data to be lost during the separation of a hard disk from the computer system.

Another disadvantage is that computer systems with rigidly attached hard disks, are limited to a particular number of hard disks because of a limited number internal hard disk connectors of the computer system. This is disadvantageous, as computer systems are often associated with many hard disks. A limitation on how many hard that disks can be used by a computer system may create practical problems for the user.

### SUMMARY OF THE INVENTION

An object of the invention is to solve at least the above problems and/or disadvantages and to provide at least the advantages described hereinafter.

Accordingly, the object to the present invention is to at least alleviate the disadvantages set forth above. Particularly, the present invention relates to a computer system and a hard disk system. The computer system and the hard disk system are not rigidly attached to each other. Accordingly, the computer system and the hard disk system are connected through an interface. In some embodiments of the present invention the interface is an Internet Protocol (IP) network. Further, the hard disk system includes a Central Processing Unit (CPU) to control the hard disk independent of a CPU of the computer system.

Accordingly, the present invention is advantageous, as the hard disk associated with the computer can be easily moved to another computer system for maximum versatility. Further, such a move of a hard disk will necessitate minimal software reconfiguration, as the hard disk system is relatively autonomous from the computer system.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

FIG. 1 is an exemplary illustration of a computer system and hard disk system in accordance with the present invention.

FIG. 2 is an exemplary illustration of the hard disk system, depicted in FIG. 1.

FIG. 3 is an exemplary illustration of the structure of software in the hard disk system.

### DETAILED DESCRIPTION OF PREFERRED EMBODIMENTS

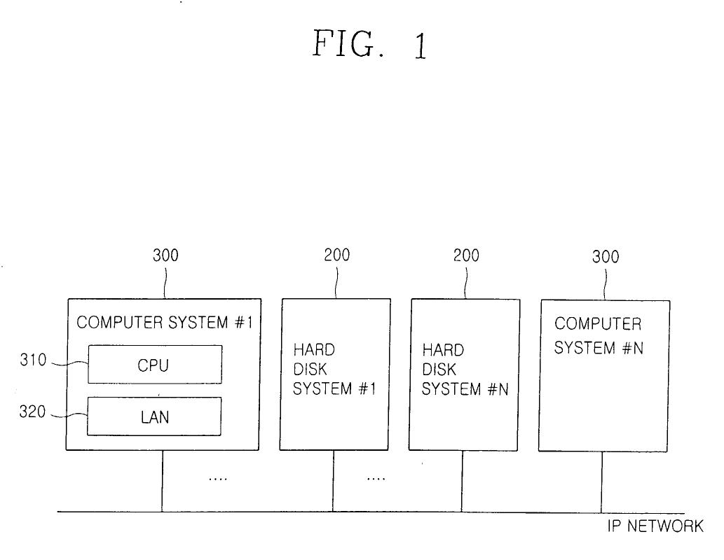

FIG. 1 illustrates computer systems 300 and hard disk systems 200. The computer systems 300 and the hard disk systems 200 are all connected together via an Internet Protocol (IP) network. The computer systems 300 each include a Central Processing Unit (CPU) 310 and a Local Area Network (LAN) interface 320. The CPU 310 is for performing the operations of the computer system in conjunction with the other installed components. The LAN 320 is for providing a network interface with the exemplary IP network such that the computer system 300 can communicate with another computer system 300 and/or hard disk systems 200.

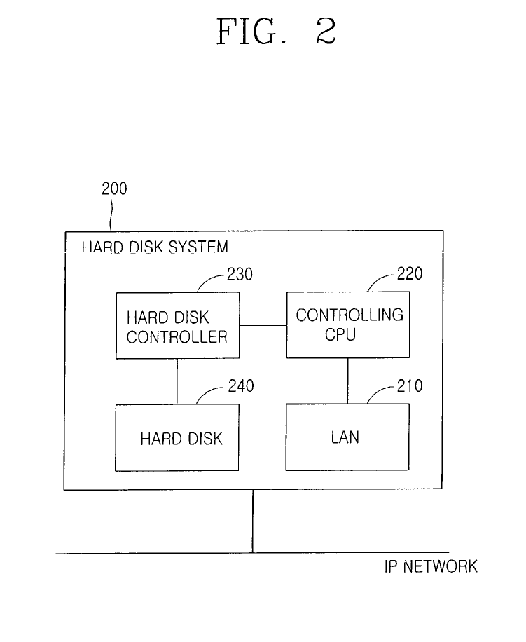

FIG. 2 illustrates hard disk system 200. Hard disk system 200 includes a hard disk controller 230, a controlling CPU 220, a LAN 210, and a hard disk 240. The hard disk 240 is for storing a data. The hard disk controller 230 is for performing a connection to the hard disk 240 in order to read the data stored in the hard disk 240. The controlling CPU 220 is for controlling the hard disk controller 230. The LAN 210 is for interfacing the hard disk system 200 with an IP network to communicate with computer system 300. LAN 210 is also for receiving a middleware connection control signal from the computer system 300.

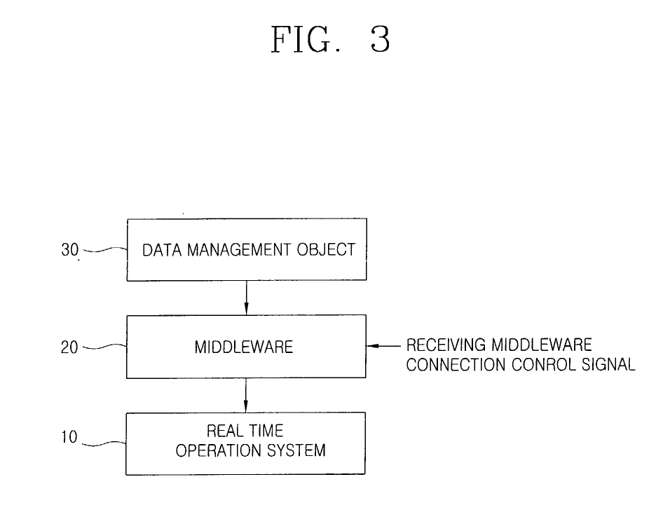

FIG. 3 is an exemplary illustration of the structure of the software of the hard disk system 200. The software includes a data management object 30, middleware 20 and real time operating system 10. The real time operating system 10 is for performing software operations in order to effectively operate the hard disk system 200 on a real time basis. Middleware 20, operated on the basis of the real time operating system 10, is configured to receive a middleware connection control signal from the computer system 300 through the IP network. Middleware 20 is further configured to establish a logical connection with the hard disk 240. Data management object 30, operated on the basis of the middleware 20, is configured to search a Database Management System (DBMS) or an File Allocation Table (FAT) by using schema or index information of a data received through the middleware 20 to locate a physical position of corresponding data on hard disk 240.

The schema or index information of the data is defined by an interface definition language (IDL). The IDL is an interface definition language and has a common data type so that distributed services can work mutually together. The purpose of the IDL is to define a capability of a distributed service. For the middleware 20, CORBA is typically used.

In embodiments of the present invention, the embodiments disclosed in FIGS. 1, 2, and 3 are used in conjunction for the operation of computer system 300 and hard disk system 200. The CPU 310 of the computer system 300 receives and interprets command language inputted to the computer system 300 from a user. The CPU 310 generates a middleware connection control signal and transmits it to an operating system (not shown) of the computer system 300. Upon receiving the middleware connection control signal, the operating system (not shown) searches a file allocation table (FAT) of a database management system (DBMS) or a file system in the operating system by using schema or index information contained in the middleware connection control signal. The middleware connection control signal tracks a physical position of corresponding data.

Once the operating system locates the position of the data, a data position signal is generated and transmitted to the CPU 310. The CPU 310 then transmits a data request signal to the hard disk system 200. The hard disk 240 of hard disk system 200 contains data positioned on the basis of the received data position signal. The hard disk system 200 transmits the data request signal to the controlling CPU 220 through the IP network. The controlling CPU 220 receives and interprets the data request signal and generates a middleware connection control signal.

The middleware control connection signal contains schema or index information of data desired to be received by the computer system 300 user. In embodiments of the present invention, the schema or the index information is defined in IDL. The controlling CPU 220 of the hard disk system 200 transmits the middleware connection control signal to the middleware 20 of the hard disk system 200. The middleware 20 receives the middleware connection control signal and transmits the schema or the index information contained in the middleware connection control signal to the database management object 30. The data management object 30 searches the DBMS or the FAT by using the received schema or index information. The data management object then tracks a physical position of the data requested by the user and transmits a data position signal to the controlling CPU 220 through the middleware 20 and the real time operating system 10.

The database management system (DBMS) is a software for easily and quickly adding, correcting and deleting numerous data in the computer. The file allocation table (FAT) is a file arrangement table for providing positions of clusters where a file is stored. When a new file is stored in the hard disk, the file is stored in at least one cluster. If a file is stored in several clusters, the file is scattered to be stored in the disk. The operating system makes a FAT entry that records a position and a sequence of each cluster (address) for the new file, reads a content in a starting cluster and a final cluster of the file with reference to directory registration information and the FAT from the disk and searches a desired file. By using an operating system of the Window 95 supporting the 32 bit FAT entry, users can manage a hard disk with a capacity reaching 2,000 GB.

The controlling CPU 220 receives the data position signal and transmits a hard disk connection control signal and a data request signal to the hard disk controller 230. The hard disk controller 230 receives the hard disk connection control signal to connect to the hard disk 240 where a corresponding data is stored and transmits the received data request signal to the hard disk 240. Upon receiving the data request signal, the hard disk 240 reads the corresponding data. The hard disk 240 then transmits the data through the IP network to the computer system 300 in response to the request for the data through the hard disk controller 230, the controlling CPU 220, and the LAN 210. The computer system 300 then transmits the received data to the CPU 310 through the LAN 320. The CPU 310 of the computer system 300 provides the data to the user, who has requested the data, through an output unit (not shown).

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. A method comprising:
generating a first signal at a computer system in response to a data read/write request, wherein the first signal is a middlewate connection control signal specific to the computer system, wherein the first signal initiates a search of a file allocation table of the computer system according to specific information included in the data read/write request;
transmitting from the computer system to a hard disk system a second signal, wherein the second signal is generated by a first central processing unit of the computer system in response to the results of the search of the file allocation table of the computer system, wherein the second signal has a communication protocol compatible with the interface between the computer system and the hard disk system;
generating a third signal at the hard disk system, wherein the third signal is generated at a central processing unit of the hard disk system, wherein the third signal is generated in response to the second signal, wherein the third signal is a middleware connection control signal specific to the hard disk system, wherein the third signal initiates a search of a file allocation table of the hard disk system; and
generating a fourth signal at the hard disk system, wherein the fourth signal is in accordance with the results of the search of the file allocation table of the hard disk system, wherein the fourth signal is configured to initiate reading or writing of data to or from a hard disk of the hard disk system.

2. The method of claim 1, wherein the hard disk system essentially consists of the central processing unit, a hard disk controller, a hard disk, and a network interface.

3. The method of claim 1, wherein the hard disk system is modular or portable.

4. The method of claim 1, wherein the interface between the computer system and the hard disk system is a local area network.

5. The method of claim 4, wherein the protocol of the local area network is an internet protocol.

6. The method of claim 5, wherein the internet protocol is Transmission Control Protocol/Internet Protocol.

7. The method of claim 1, wherein an operating system of the computer system is Microsoft Windows.

8. The method of claim 7, wherein the operating system of the computer system is Windows 95.

9. The method of claim 7, wherein the operating system of the computer system is different from an operating system of the hard disk system.

10. The method of claim 1, wherein the middleware connection control signal specific to the computer system and the middleware connection control signal specific to the hard disk system are software that are invisible to users which takes two or more different applications and makes them work seamlessly together.

11. The method of claim 1, the hard disk system comprises a second central processing unit.

12. The method of claim 11, wherein the first central processing unit has a larger capacity than the second central processing unit.

13. The method of claim 11, wherein the second central processing unit is configured to exclusively operate the functions of the hard disk.

14. The method of claim 11, wherein the second central processing unit is configured to be exclusively associated with the hard disk.

15. The method of claim 14, wherein the second central processing unit is the only central processing unit comprised in the hard disk system.

16. The method of claim 11, wherein:
the second central processing unit is configured to be associated with a plurality of hard disks; and
the plurality of hard disk comprises the hard disk.

17. The method of claim 1, wherein the hard disk system comprises a plurality of hard disks.

18. The method of claim 17, wherein:
the hard disk system comprises a plurality of central processing units;
wherein the plurality of central processing units comprises the second central processing unit; and
wherein each one of the plurality of central processing units is exclusively associated with one of the plurality of hard disks.

19. A method comprising:
generating a first middleware connection control signal in response to command language inputted into a computer system, wherein the command language corresponds to a data storage access signal;
transmitting the first middleware connection control signal to an operating system of the computer system;
searching a first file allocation table or a first database management system at the operating system using schema or index information contained in the first middleware connection control signal;
generating at the operating system a first data position signal according to results of the searching of the first file allocation table;
transmitting the first data position signal from the operating system to a first central processing unit of the computer system;
generating at the first central processing unit a data request signal in accordance with the first data position signal;
transmitting from the first central processing unit to a hard disk system a data request signal in accordance with the first data position signal;
inputting the data request signal into a second central processing unit of the hard disk system;
generating a second middleware connection control signal at the second central processing unit, wherein the second middleware connection control signal is generated in response to the first data position signal;
transmitting the second middleware connection control signal to middleware of the hard disk system;
transmitting, from the middleware to a database management object, schema comprised in the second middleware connection control signal;
searching, at the database management object, a second database management system or a second file allocation table for a physical position of the requested data on a hard drive of the hard drive system;
generating at the database management object a second data position signal in accordance with results of the searching of the second database management system or the second file allocation table;
transmitting from the database management object to the middleware the second data position signal;
transmitting from the middleware to a real time operating system the second data position signal;
transmitting from the real time operating system to the second central processing unit the second data position signal;
generating a hard disk connection control signal and a data request signal at the second central processing unit in response to the second data position signal;
transmitting the hard disk connection control signal and the data request signal to a hard disk controller; and
transmitting from the hard disk controller to the hard disk the data request signal.

20. An apparatus comprising:
a computer system configured to generate a first middleware connection control signal in response to command language inputted into the computer system, wherein the command language corresponds to a data storage access signal;
an operating system of the computer system configured to receive the first middleware connection control signal from the computer system, configured to search a first file allocation table or a first database management system using schema or index information contained in the first middleware connection control signal, and configured to generate a first data position signal according to results of the searching of the first file allocation table;
a first central processing unit of the computer system configured to receive the first data position signal from the operating system and configured to generate a first data request signal in accordance with the first data position signal;
a hard disk system configured to receive the first data request signal;
a second central processing unit of the hard disk system configured to receive the first data request signal and configured to generate a second middleware connection control signal in response to the first data request signal;
middleware of the hard disk system configured to receive the second middleware connection control signal;
a database management object configured to receive from the middleware schema, wherein the schema are comprised in the second middleware connection control signal, configured to search at the database management object a second database management system or a second file allocation table for a physical position of requested data on a hard drive of the hard drive system, configured to generate a second data position signal in accordance with results of the searching of the database management system or the file allocation table, and configured to transmit to the middleware the second data position signal;
a real time operating system configured to receive from the middleware the second data position signal and configured to transmit to the second central processing unit the second data position signal, wherein the second central processing unit is configured to generate a hard disk connection control signal and a data request signal in response to the second data position signal;
a hard disk controller configured to receive the hard disk connection control signal and the data request signal to a hard disk controller and configured to transmit to the hard disk the data request signal.
